(19) United States
(12) Patent Application Publication
(10) Pub. No.: US 2011/0109556 A1
(43) Pub. Date: May 12, 2011

(54) SPECIALIZED KEYS AND ARRANGEMENTS THEREOF FOR ELECTRONIC DEVICES

(75) Inventors: Harriss C.N. Ganey, Cary, NC (US); David W. Hill, Cary, NC (US); Go Osaki, Yokohama-shi (JP); Hisashi Shima, Yamato-shi (JP); Aaron M. Stewart, Raleigh, NC (US); John D. Swansey, Durham, NC (US); Tomoyuki Takahashi, Fujisawa-shi (JP)

(73) Assignee: Lenovo (Singapore) Pte. Ltd., Singapore (SG)

(21) Appl. No.: 12/691,980

(22) Filed: Jan. 22, 2010

Related U.S. Application Data
(63) Continuation-in-part of application No. 12/616,768, filed on Nov. 11, 2009.

(51) Int. Cl. G06F 3/02; B41J 5/10

(52) U.S. Cl. 345/168; 400/490

(57) ABSTRACT

Embodiments of the invention provide an electronic device, such as a laptop PC, with a keyboard having specialized keys. The specialized keys according to embodiments of the invention are chamfer-less, configured with a larger, “D” shaped striking surface having a concavity therein.

### CROSS REFERENCE TO RELATED APPLICATIONS

This application is a continuation-in-part of U.S. patent application Ser. No. 12/616,768, filed on Nov. 11, 2009 and entitled “SPECIALIZED KEYS AND ARRANGEMENTS THEREOF FOR ELECTRONIC DEVICES”, the contents of which are incorporated by reference.

### BACKGROUND

Subject matter described herein is generally directed to keys and keyboards for electronic devices such as laptop or notebook personal computers (a “laptop PC”). Specifically, the subject matter relates to specialized shapes, sizes and positioning of keys to achieve more efficient keyboard arrangements.

Keyboards for electronic devices such as a laptop PC are typically designed for minimal space occupancy or footprint. This involves minimizing the overall size and width of the keyboard. Keys of a keyboard typically come in one of a few different general varieties.

Some keyboards employ keys having a chamfer (also referred to as a “skirt”). The chamfer configuration is useful for a number of reasons, including giving the illusion or appearance that the keys of the keyboard are not so tightly packed together in the small space available. The chamfer of these keys occupies additional space, and thus these keys have a reduced striking area. In the striking area, which is generally square or rectangular in shape (as viewed from the top), a concave striking surface is often employed, configured to accommodate the user's fingertip more naturally.

Other keyboards employ keys that forego the chamfer, opting for a key that drops straight down (or nearly so) to the keyboard proper (a so-called “chiclet” or “island” style design). These keyboards may employ the chamfer-less (that is, without a skirt) key configuration coupled with a somewhat larger striking surface which is flat (rather than curved) and also generally square or rectangular in shape (as viewed from the top).

Other keyboard and keypad configurations exist and, like the foregoing configurations, have advantages and disadvantages unique to the configurations employed.

### BRIEF SUMMARY

Various embodiments of the invention provide a chamfer-less, “D-shaped” key configuration with a generally concave striking surface (herein referred to simply as a “chamfer-less” key or a “D-shaped” key for ease of description) and arrays thereof. The embodiments of the invention allow for a large striking area on keys which when arrayed on a keyboard leads to a more visually comfortable appearance for a user that is also easier and more natural to use than standard keyboards. In and among other features, the chamfer-less key configuration and arrays thereof, according to embodiments of the invention, reduce errant key strikes.

In summary, one aspect provides an apparatus comprising: a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys.

Another aspect provides a system comprising: a processor; a display; and a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys; wherein the processor is configured to receive keystrokes from the keyboard and output display data related to the keystrokes on the display.

A further aspect provides a method, the method comprising: receiving a signal from a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys; and displaying data related to the signal on a display.

For a better understanding of exemplary embodiments, together with other and further features and advantages thereof, reference is made to the following description, taken in conjunction with the accompanying figures, and the scope of the claimed embodiments of the invention will be pointed out in the appended claims.

### BRIEF DESCRIPTION OF THE SEVERAL VIEWS OF THE DRAWINGS

FIG. 1 illustrates a conventional electronic device and keyboard (laptop PC).

FIG. 2(a-b) illustrates standard chamfered keys.

FIG. 3 illustrates a keyboard having specialized keys therein according to one embodiment.

FIG. 4 illustrates specialized keys according to one embodiment.

FIG. 5 illustrates top and profile views of a traditional key and several specialized keys according to various embodiments.

FIG. 6 illustrates an enlarged profile view of a traditional key and several specialized keys according to various embodiments.

FIG. 7 illustrates an array of specialized keys according to an embodiment.

FIG. 8 illustrates an array of specialized keys according to an embodiment.

FIG. 9 illustrates an array of specialized keys according to an embodiment.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments of the invention. One skilled in the relevant art will recognize, however, that the various embodiments of the invention can be practiced without one or more of the specific details, or with other methods, components, materials, etc. In other instances, well-known structures, materials, or operations are not shown or described in detail to avoid obfuscation.

The inventors have recognized that although a wide variety of key configurations have been employed in the past, none has yet to achieve an appropriate balance between visual appeal for the user and maximum utility, for example in facilitating ease of use and minimizing errant key strikes. The inventors have recognized that chamfered keys are more difficult to use. A core issue in this regard is that the chamfer inherently brings the perimeters of adjacent keys closer together. While the chamfer design helps to reduce errant presses of adjacent keys in some respects, it inherently cannot eliminate them. Users fingers can still overreach while pressing an intended key and press the chamfer of an adjacent key that is at it's resting (hence, higher) relative position. The inventors have therefore discovered that a chamfer-less design reduces errant presses, as the perimeters of adjacent keys are further apart.

While chamfer-less keys have been employed in the past, these configurations have not optimized the touch and feel of the keys, and moreover have not maximized the use of a chamfer-less configuration. Likewise, prior configurations of chamfered keys have aspects (for example, a curved striking surface) that make them appealing, yet have significant drawbacks, including at least wasted space (due to the chamfered configuration) and difficult use (more errant key strikes).

Accordingly, at least one embodiment of the instant invention provides an electronic device, such as a laptop PC, with a keyboard having specialized keys. The specialized keys according to embodiments of the invention are chamfer-less, configured with a larger, generally “D” shaped striking surface having a concavity therein. The use of chamfer-less keys provides more flexibility to the available keyboard layouts. As discussed herein, the extra space obtained with using chamfer-less keys can be used in a variety of ways, including providing a larger striking surface. Additionally, the pitch (that is, the centered placement of the keys) can be changed; however, this is not presently preferred due to the touch typist's familiarity with current key locations.

The illustrated embodiments of the invention will be best understood by reference to the figures. The following description is intended only by way of example, and simply illustrates certain selected embodiments consistent with the invention as claimed herein.

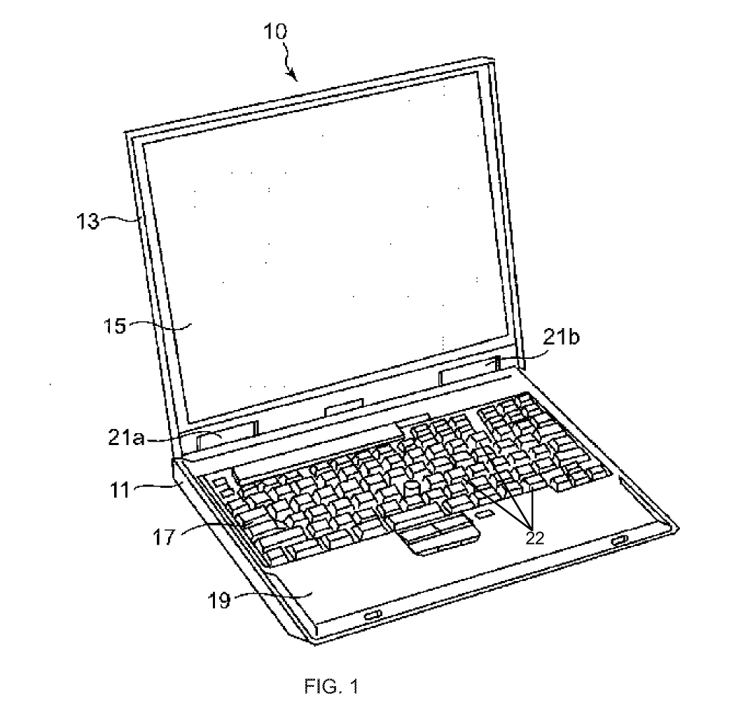

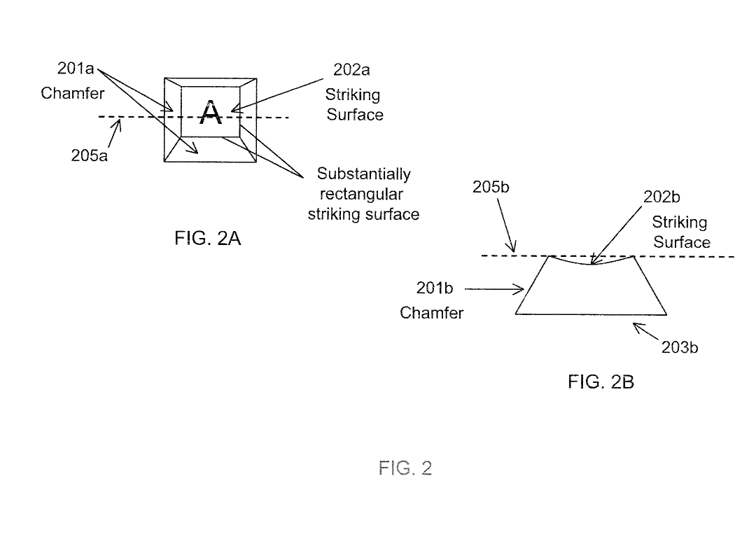

FIG. 1 depicts a high level view of a non-limiting and exemplary electronic device (10), a laptop PC in this example, in which it may be desirable to provide input from a keyboard. The laptop PC (10) contains a display casing (13) having a display medium (15) therein. The display casing (13) is connected via hinges (21a, 21b) to a system casing (11) of the laptop PC (10). The system casing (11) contains a keyboard arrangement (17) (where the keys are arrayed in a standard QWERTY keyboard format) and a palm rest (19), as well as many of the functional components of the device (not shown). The keyboard arrangement (17) contains a plurality of keys for typing and executing a variety of functions. The keyboard arrangement (17) depicted in FIG. 1 employs keys configured with a chamfer (22) (an enlarged illustration is provided in FIG. 2(a-b)). As shown, the chamfered keys a packed fairly tightly with the chamfering of adjacent keys positioned relatively close to one another, which can lead to errant key strikes (discussed further herein).

Referring to FIG. 2(a-b), one of the chamfered keys illustrated in FIG. 1 is illustrated in a top view (FIG. 2a) and a side-on view (FIG. 2b). As shown in FIG. 2a, the chamfer (201a) extends down from the striking surface (202a) to the bottom or base of the key configuration such that the striking surface (202a) is smaller in area than the base (refer to 203b) of the chamfered key. The amount of chamfering applied can be modulated to varying degrees in different configurations; however the chamfering of the top edge is generally substantially less than that of the left, right and bottom (or lower) egdes. The striking surface (202a) is substantially rectangular in shape. A reference axis (205a) is provided for ease of discussion.

Turning to FIG. 2b, a side on view of the chamfered key is illustrated. The chamfer (201b) is illustrated on one side of the key, extending to the base (203b). Notably, chamfered keys often have a concave striking surface (202b) that provides a more natural feel for the typist. A reference axis (205b), which corresponds to axis (205a), is provided for illustration of the concavity in the striking surface (202b).

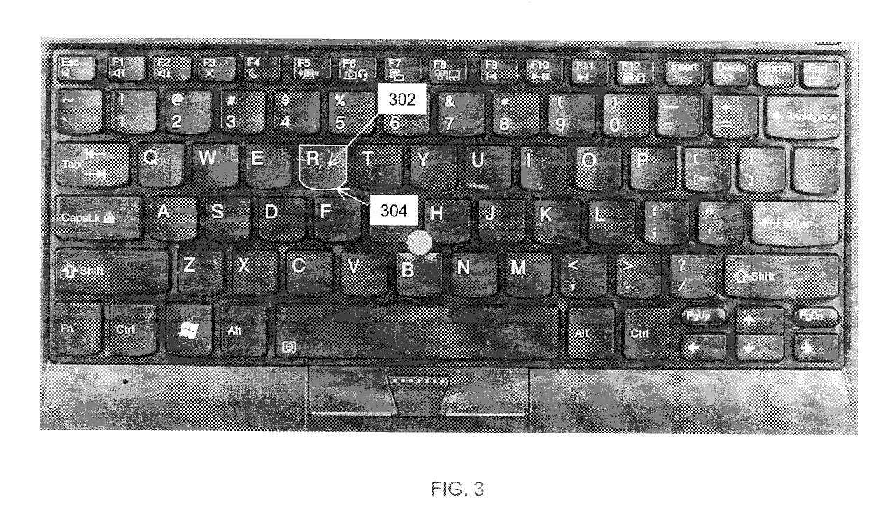

FIG. 3 illustrates a top view of a keyboard having specialized keys according to an embodiment of the invention. According to an embodiment of the invention, the keys are chamfer-less (that is, extending substantially straight downwards from the top edges towards the keyboard). The striking surface (302) of has a curved bottom edge (304) and a substantially straight upper edge and side edges, giving the top of the key (that is, the striking surface 302) generally a “D” shape (when rotated by 90 degrees to the right, as illustrated). The curved bottom edge is preferred because it has been discovered to give the user a more comfortable typing experience using the chamfer-less keys and leads to far less missed keys (less errant key strikes). Thus, extending the lower edge, as by utilizing the curved edge, is preferable.

Some main benefits of the curved edge configuration are summarized below. First, a curved bottom edge visually accentuates the dished (concave) top (striking) surface. This helps preserve familiarity for the user by respecting attributes of key shape traditionally regarded as beneficial and improves visual and tactile cues for finger placement. Moreover, a curved bottom edge lengthens the vertical axis of the key top (striking surface) (from an overhead view) which creates more key top surface, which is good for typing comfort, while allowing less key mass at the bottom left and right corners of the key. This void of material in the corner junctions of adjacent keys according to embodiments of the invention is helpful in reducing errant key presses. Keys on a typical keyboard are not in a perfect grid and are hence staggered row to row. This creates a situation in which the user's finger can overreach from an intended key and have part of the finger in the corner junction between keys of different rows. This overreaching typically occurs at the top edges of intended keys due to hand placement and finger trajectory of typing. A curved bottom edge thus creates a void of material in these corner junctions where errant key presses are more likely on any conventional key shape that extends further into the corner junctions.

Moreover, it should be noted that removing the chamfer enables somewhat larger striking surface (302) to be employed, which further enhances the typist's experience, again for example resulting in less missed keys. Further, the chamfer-less keys allow more flexibility in placement of keys (with respect to one another) such that the keyboard configuration can be further customized utilizing the extra space (formerly occupied by the chamfer). In the illustrated embodiment, the extra space (formerly occupied by the chamfer) has been occupied by additional striking surface (302) area. Moreover, it is noted that the chamfer-less design of according to embodiments of the invention is more visually appealing to users.

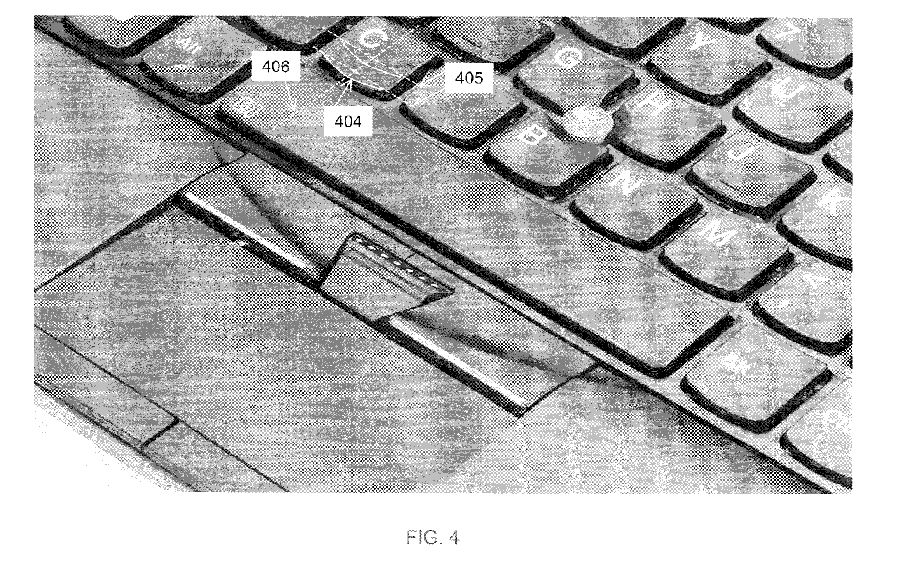

Turning to FIG. 4, a specialized key is illustrated according to an embodiment of the invention. As shown, the generally concave striking surface (404) (along a first axis (406)) of the chamfered key design is retained in the chamfer-less key according to an embodiment of the invention. This concave striking surface (404) is retained because it has been discovered that it is preferred by typists to have the feel of the traditional chamfered key (traditional key top concave shape), whereas typical chamfer-less keys (not shown) utilize a substantially flat striking surface. Moreover, the curved striking surface (404) may lead to less errant key strikes by the user due to increased comfort, though as currently understood, less errant key strikes are mainly accomplished due to jettisoning of key chamfers and/or lack of key chamfer combined with the curved bottom edge (as discussed herein). The reference axis (405) is again provided for aid in illustrating the concavity of the striking surface (404).

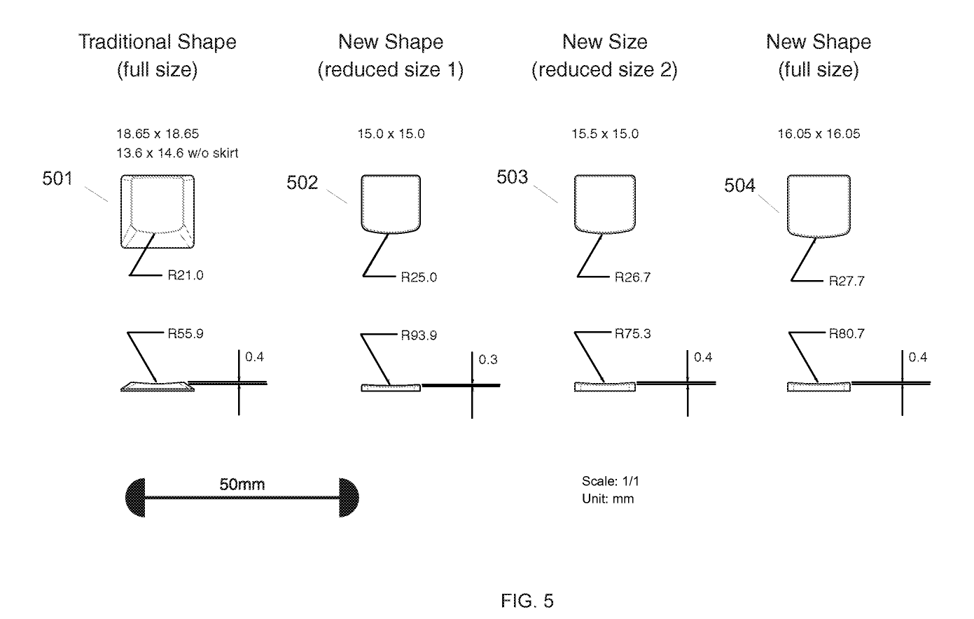

Referring now to FIG. 5, top and profile views of a traditional (conventional chamfered) key and several specialized keys according to various embodiments of the invention are illustrated. As shown, a chamfered key 501 has an overall larger profile, largely imparted by including the chamfer. Comparatively, the specialized keys (502, 503 and 504) have a reduced overall size or footprint, yet employ a larger striking surface. That is, the top or striking surface of the specialized, chamfer-less keys (502, 503 and 504) comprises essentially the entire area of the keys (as viewed from the top as in FIG. 5). The top or striking surface of the specialized keys have a curved lower edge. The curve of the lower edge surface, as defined for example by the radius, can be of a variety of shapes. Some presently preferred radius measurements are a range of 15-30 mm and a range of not less than one-half a width of the key and 40 mm. As illustrated, the radius of the lower edge curve is 27.7 mm (full size), 25.0 mm (reduced size 1) and 26.7 (reduced size 2).

The profiles of these keys (501, 502, 503 and 504) illustrate that the traditional shaped (chamfered) key (501) contains a concavity or dished striking surface (0.4 mm, as illustrated) and moreover that the specialized keys (502, 503 and 504) also contain a concavity (for example 0.3 mm or 0.4 mm as illustrated, which can be varied depending upon the implementation chosen). The choice of the exact measurements of the specialized keys may be dictated by several factors, such as the overall keyboard layout desired (for example, larger (full size) keys may be employed in a desktop-connected keyboard versus a notebook keyboard integrated into the device, which may necessitate a smaller overall keyboard size and hence reduced sized keys).

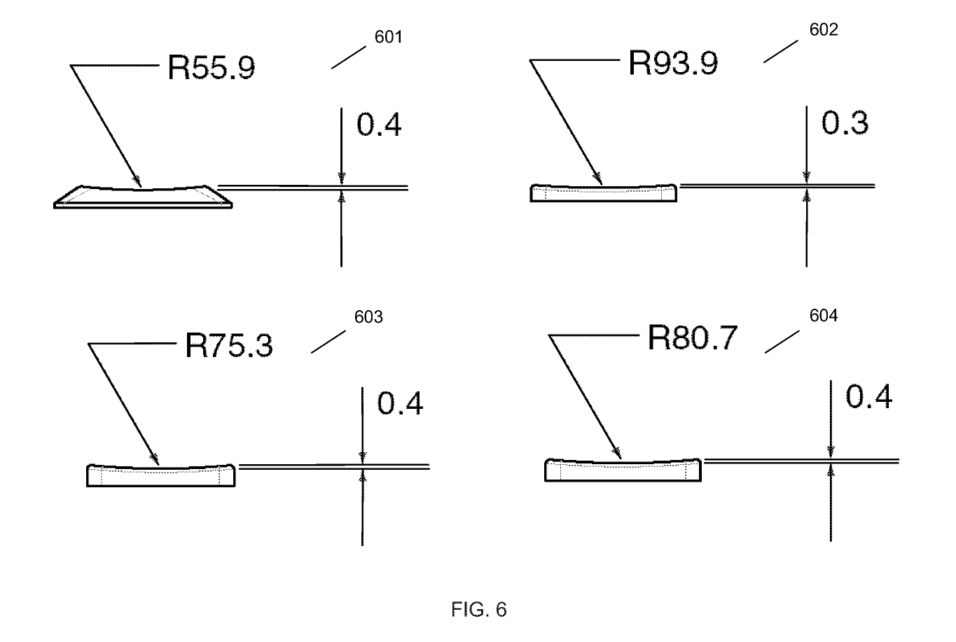

FIG. 6 illustrates an enlarged view of keys (601, 602, 603 and 604) corresponding to the profiles of the keys (501, 502, 503 and 504) of FIG. 5 for ease of viewing. The key profiles (601, 602, 603 and 604) illustrate the dished or concave shape of the striking (top) surface of the keys, which according to embodiments of the invention are employed to more naturally accommodate the user's fingertips, providing at least a more natural touch and feel.

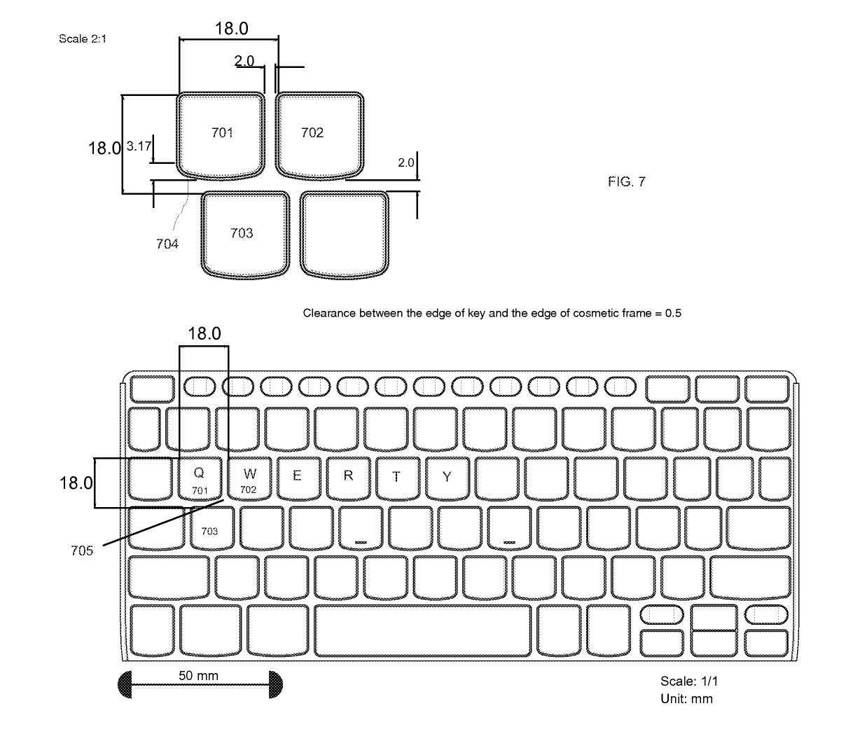

Referring to FIG. 7, an array of specialized keys according to an embodiment of the invention is illustrated. As shown, the D shaped (chamfer-less) keys are arrayed on a QWERTY keyboard, with spacing between columns and rows of keys indicated. The overall length and width of the keys is approximately 16.0 mm. The spacing between adjacent keys 701, 702, and 703 is shown in the upper view, enlarged, and is approximately 2.0 mm, both with respect to the side edges of adjacent keys (column spacing) and the top edge/bottom edges of adjacent keys (row spacing). The curvature of the bottom edge of the keys is also illustrated 704. The illustrated embodiment of the invention provides a curved bottom surface forming an arc of approximately 3.17 mm height, as shown. Thus, the curved lower edge of upper row keys 701, 702 and the upper straight edge of a key from a lower row, 703, define a void of material 705.

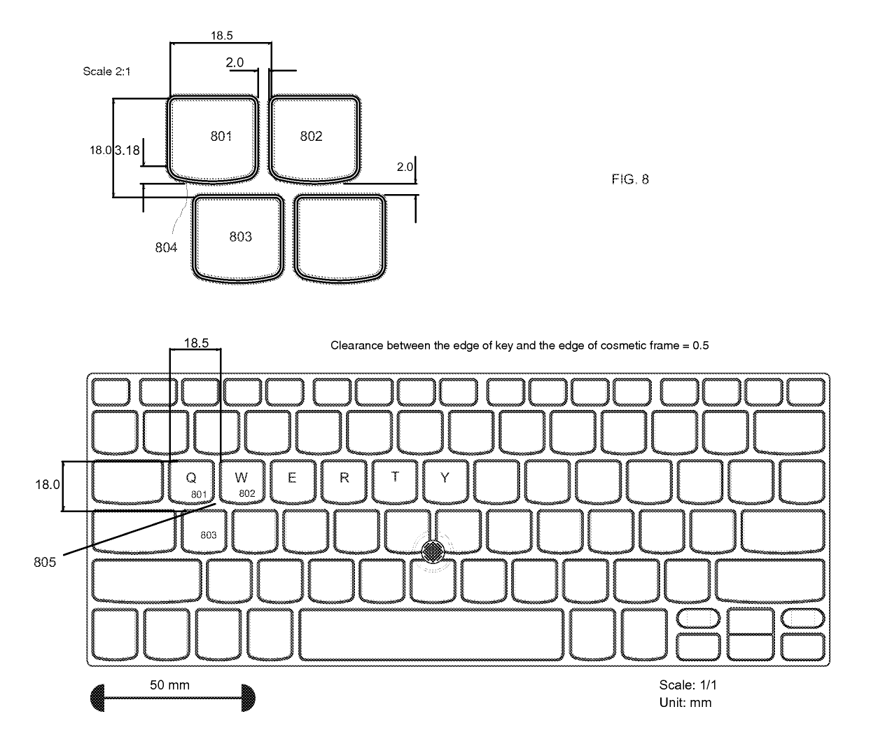

Referring to FIG. 8, an array of specialized keys according to an embodiment of the invention is illustrated. As shown, the D shaped (chamfer-less) keys are arrayed on a QWERTY keyboard, with spacing between columns and rows of keys indicated. The overall length of the keys is approximately 16.0 mm, while the width of the keys is 16.5 mm. The spacing between adjacent keys 801, 802, and 803 is shown in the upper view, enlarged, and is again approximately 2.0 mm, both with respect to the side edges of adjacent keys (column spacing) and the top edge/bottom edges of adjacent keys (row spacing). The curvature of the bottom edge of the keys is also illustrated 804. The illustrated embodiment of the invention provides a curved bottom surface forming an arc of approximately 3.18 mm height, as shown. Thus, the curved lower edge of upper row keys 801, 802 and the upper straight edge of a key from a lower row, 803, define a void of material 805.

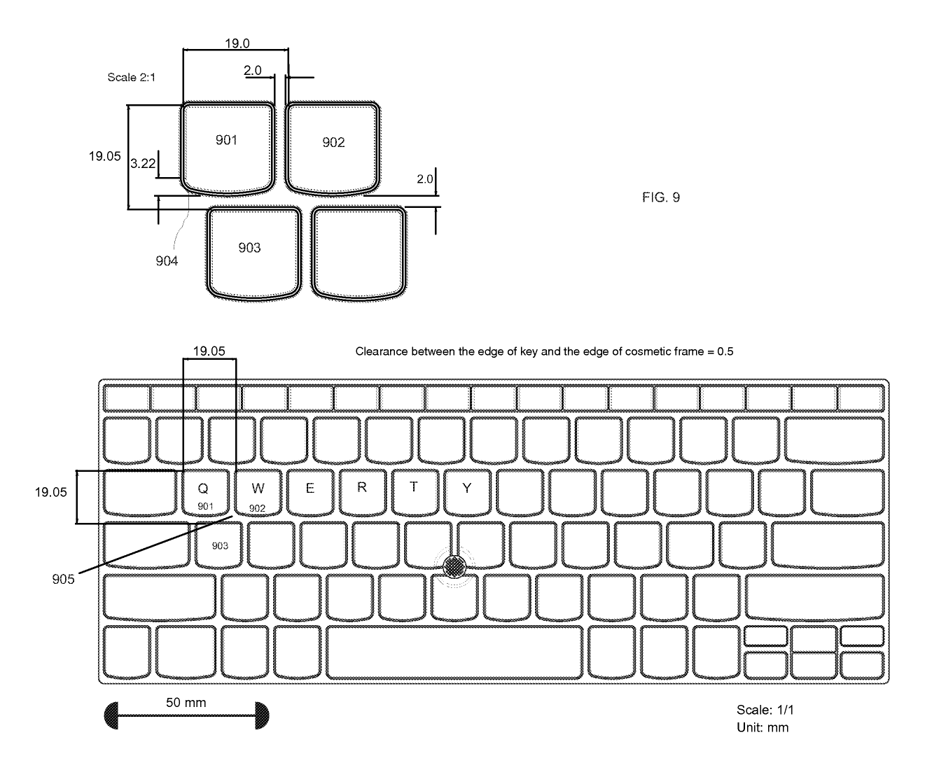

Referring to FIG. 9, an array of specialized keys according to an embodiment of the invention is illustrated. As shown, the D shaped (chamfer-less) keys are arrayed on a QWERTY keyboard, with spacing between columns and rows of keys indicated. The overall length and width of the keys is approximately 17.05 mm. The spacing between adjacent keys 901, 902, and 903 is shown in the upper view, enlarged, and is again approximately 2.0 mm, both with respect to the side edges of adjacent keys (column spacing) and the top edge/bottom edges of adjacent keys (row spacing). The curvature of the bottom edge of the keys is also illustrated 904. The illustrated embodiment of the invention provides a curved bottom surface forming an arc of approximately 3.22 mm height, as shown. Thus, the curved lower edge of upper row keys 901, 902 and the upper straight edge of a key from a lower row, 903, define a void of material 905.

In brief recapitulation, at least one embodiment of the invention provides an electronic device, such as a laptop PC, with a keyboard having specialized keys. The specialized keys according to embodiments of the invention are chamfer-less, configured with a larger, “D” shaped striking surface having a curvature at the lower edge and having a concavity therein. The use of chamfer-less keys provides more flexibility to the available keyboard layouts/arrays. As discussed herein, the extra space obtained with using chamfer-less keys can be used in a variety of ways, including providing a larger striking surface. Additionally, the pitch (that is, the centered placement of the keys) can be changed; however, this is not presently preferred due to the touch typist's familiarity with current key locations.

In the figures and specification there has been set forth a preferred embodiment of the invention and, although specific terms are used, the description thus given uses terminology in a generic and descriptive sense only and not for purposes of limitation.

What is claimed is:

1. An apparatus comprising:
a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys.

2. The apparatus according to claim 1, wherein the array comprises column spacing of approximately 2.0 mm.

3. The apparatus according to claim 2, wherein the array row spacing of approximately 2.0 mm.

4. The apparatus according to claim 1, wherein the array of chamfer-less keys are arrayed in a standard QWERTY keyboard format.

5. The apparatus according to claim 1, wherein the curved lower edge forms an arc of approximately 3.17 mm height.

6. The apparatus according to claim 1, wherein the curved lower forms an arc of approximately 3.18 mm height.

7. The apparatus according to claim 1, wherein the curved lower edge forms an arc of approximately 3.22 mm height.

8. The apparatus according to claim 1, wherein a length and a width of the chamfer-less keys are approximately 16.0 mm.

9. The apparatus according to claim 1, wherein a length of the chamfer-less keys is approximately 16.0 mm and a width the chamfer-less keys is approximately 16.5 mm.

10. The apparatus according to claim 1, wherein a length and a width of the chamfer-less keys are approximately 17.05 mm.

11. A system comprising:
a processor;
a display; and
a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys;
wherein the processor receives keystrokes from the keyboard and displays data related to the keystrokes on the display.

12. The system according to claim 11, wherein the array comprises column spacing of approximately 2.0 mm.

13. The system according to claim 12, wherein the array comprises row spacing of approximately 2.0 mm.

14. The system according to claim 11, wherein the array of chamfer-less keys are arrayed in a standard QWERTY keyboard format.

15. The system according to claim 11, wherein the curved lower edge forms an arc of approximately 3.17 mm height.

16. The system according to claim 11, wherein the curved lower forms an arc of approximately 3.18 mm height.

17. The system according to claim 11, wherein the curved lower edge forms an arc of approximately 3.22 mm height.

18. The system according to claim 11, wherein a length and a width of the chamfer-less keys are approximately 16.0 mm.

19. The system according to claim 11, wherein a length of the chamfer-less keys is approximately 16.0 mm and a width the chamfer-less keys is approximately 16.5 mm.

20. A method, the method comprising:
receiving a signal from a keyboard having an array of chamfer-less keys therein, the chamfer-less keys comprising a striking surface, the striking surface being generally concave along a first axis and having a straight top edge and a curved lower edge such that the array of chamfer-less keys define one or more voids substantially bounded by a straight top edge of a chamfer-less key and a lower left edge of a chamfer-less key of an upper row of chamfer-less keys and a lower right edge of a chamfer-less key of the upper row of chamfer-less keys; and
displaying data related to the signal on a display.
